(19) United States
(12) Patent Application Publication
(10) Pub. No.: US 2022/0376919 A1
(43) Pub. Date: Nov. 24, 2022

(54) Blockchain-enabled secure messaging system, device, and method using blockchain validation and biometric authentication

(71) Applicant: PECX Inc., Porter Ranch, CA (US)

(72) Inventor: Lisa Goshon, Porter Ranch, CA (US)

(21) Appl. No.: 17/868,674

(22) Filed: Jul. 19, 2022

Related U.S. Application Data
(63) Continuation-in-part of application No. 16/744,055, filed on Jan. 15, 2020, now abandoned.
(60) Provisional application No. 62/918,179, filed on Jan. 16, 2019.

(51) Int. Cl. H04L 9/32; H04L 9/00

(52) U.S. Cl. CPC H04L 9/3231; H04L 9/50

(57) ABSTRACT

A secure messaging system, includes a blockchain network, including a plurality of computational nodes, each comprising a secure message blockchain of cryptographically linked secure message blocks, each comprising secure message objects; a biometric authentication server; a secure messaging server, including a secure message store; and secure messaging devices that enable a sending user to login with biometric authentication and create a secure message object, including message information, recipients, a biometric authentication flag, attachments, expiration time, current and prior message identifiers, message status, prior related message, and smart contracts; such that a receiving user is required to perform a blockchain validation and a biometric authentication to access the secure message object. Also disclosed is a method for secure document messaging, including creating message, storing message, sending message, receiving message, and accessing message.

### CROSS-REFERENCE TO RELATED APPLICATIONS

This application is a Continuation-In-Part of U.S. Non-Provisional application Ser. No. 16/744,055, filed Jan. 15, 2020; which claims the benefit of U.S. Provisional Application No. 62/918,179, filed Jan. 16, 2019; both of which are hereby incorporated herein by reference in their entirety.

### FIELD OF THE INVENTION

The present invention relates generally to the field of document management and messaging, and more particularly to methods and systems for securing mobile messages using a blockchain-enabled messaging system with blockchain validation and biometric authentication.

### BACKGROUND OF THE INVENTION

Of the almost eight billion people on planet earth, nearly 33% (approx. 2.4 billion) own some type of mobile device or personal digital assistant (PDA). Nearly half use the device to send and receive files containing digital content (photo, video or text) either directly to an individual or post on social media platforms, such as Facebook, Twitter, Instagram, etc.

With so much data being transmitted, clearly a major concern with sharing digital content using a mobile device is security. Hacking, privacy breaches and data contamination have become as commonplace as making a phone call. Unfortunately, as technology evolves so do hackers.

Biometric authentication is the highest form of data security used today to protect sensitive and proprietary data. Turning the biometric authentication function on or off in any biometric access control system is normally controlled at the systems administrator level.

Currently, biometric authentication access management is “only” used to access (or unlock) a smartphone, a computing device such as a computer, tablet, kiosk, or an application or web page in the transaction of processing financial information such as biometric payment cards, point-of-sale and payment systems, mobile wallet applications and cash transfer systems.

In addition, current biometric authentication access management systems are controlled at the network or application level and not by the user. Therefore, users do not have the ability to “grant” or “deny” others access to their data using biometric sensing technologies such as face recognition, iris, Touch ID, voice recognition, etc.

As such, considering the foregoing, it may be appreciated that there continues to be a need for novel and improved devices and methods for securing digital content with biometric authentication.

### SUMMARY OF THE INVENTION

The foregoing needs are met, to a great extent, by the present invention, wherein in aspects of this invention, enhancements are provided to the existing model for securing digital content with biometric authentication.

In an aspect, a secure messaging system can include:
a) a secure messaging server, which can include:
   i. a plurality of secure message objects; and
b) a secure messaging device;
wherein the secure messaging device can be configured to require the sending user to perform a first sender biometric authentication of the sending user, during login to the secure messaging device;
wherein if the first sender biometric authentication succeeds, the secure messaging device can be configured to enable a sending user to create a first secure message object and send the first secure message object to at least one receiving user, wherein the first secure message object comprises: message information; a sender identifier, which identifies the sending user; and a first recipient identifier, which identifies the at least one receiving user.

In a related aspect, the secure messaging server can further include:
a) a secure message store, which includes the plurality of secure message objects;
wherein:
   i. if the first sender biometric authentication succeeds, the secure messaging device can be configured to store the first secure message object in the secure message store of the secure messaging server.

In another related aspect, the secure messaging device can further include:
a) a messaging controller, which is configured to receive the first secure message object in communication with the secure message store of the secure messaging server;
wherein the messaging controller is configured to require a first receiving user to perform a receiver biometric authentication of the first receiving user, wherein:
   i. if the receiver biometric authentication succeeds, the messaging controller is configured to enable the first receiving user to access and open the first secure message object.

In another related aspect, the secure messaging system can further include:
a) a blockchain network, which can include:
   i. a plurality of computational nodes, wherein each computational node can include:
      1) a secure message block chain, which can include:
         a. a plurality of cryptographically linked secure message blocks, each comprising at least one secure message object.

In a further related aspect, the first secure message object can further include:
a) a message status;
wherein when the secure messaging device sends the first secure message object to the at least one receiving user, the secure messaging device can be configured to save and commit the first secure message object to a first secure message block of the secure message block chain, wherein the message status of the first secure message object, is set to sent.

In a yet further related aspect, the first secure message object can further include:
a) a current message identifier;
wherein when the secure messaging device receives the first secure message object, the secure messaging device can be configured to verify that the first secure message object is stored in the secure message block chain, by searching the secure message block chain for a matching secure message object, wherein the current message identifier is equal to a matching message identifier of the matching secure message object; and such that a matching message status of the matching secure message object set to sent;
wherein, if the matching secure message object is not found in the secure message block chain, the secure messaging device is configured to not enable the first receiving user to perform the receiver biometric authentication and the secure messaging device is configured to not enable the first receiving user to access and open the first secure message object.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1A is a schematic diagram illustrating a secure messaging system, according to an embodiment of the invention.

FIG. 1B is a schematic diagram illustrating a secure messaging system, according to an embodiment of the invention.

FIG. 1C is a schematic diagram illustrating a secure messaging system, according to an embodiment of the invention.

FIG. 2 is a schematic diagram illustrating a secure messaging server, according to an embodiment of the invention.

FIG. 3 is a schematic diagram illustrating a secure messaging device, according to an embodiment of the invention.

FIG. 4 is a flowchart illustrating steps that may be followed, in accordance with one embodiment of a method or process of secure document messaging.

FIG. 5 is a schematic diagram illustrating a date structure for a secure message object, according to an embodiment of the invention.

FIG. 6A is a schematic diagram illustrating a secure message block chain, according to an embodiment of the invention.

FIG. 6B is a schematic diagram illustrating a secure message block chain, according to an embodiment of the invention.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

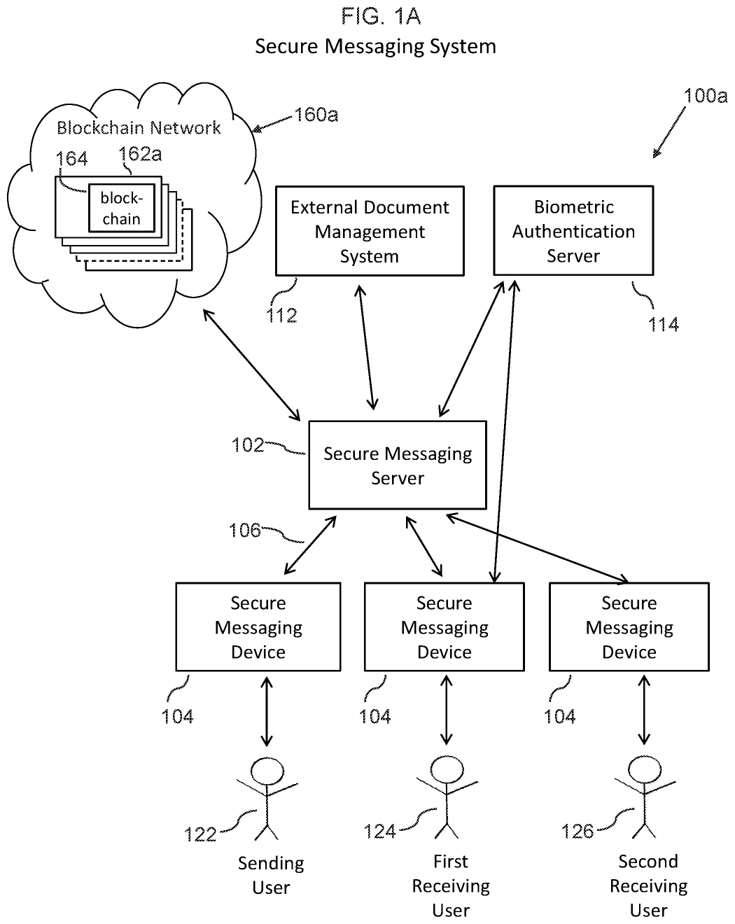

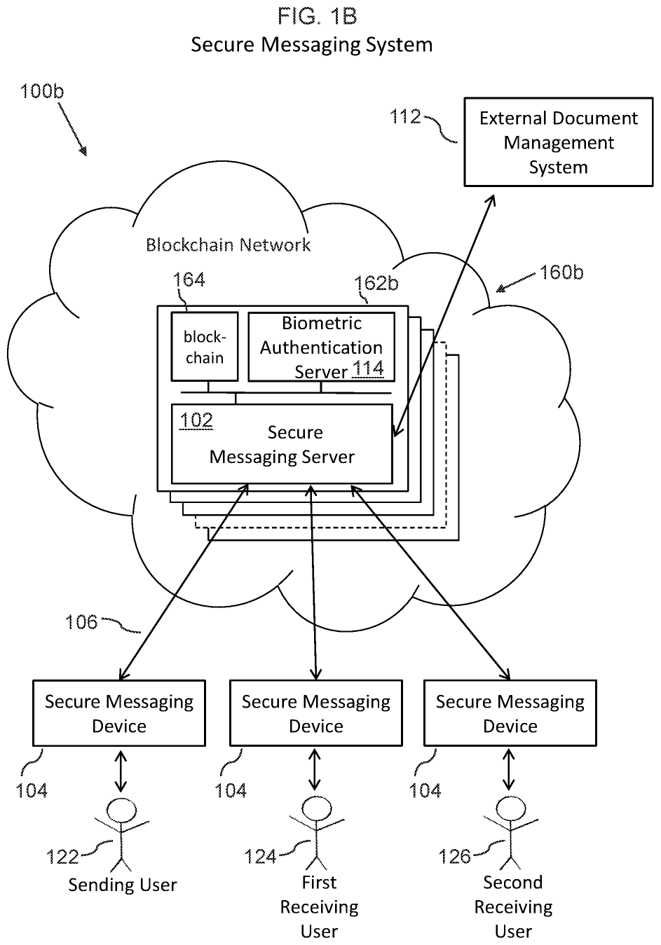

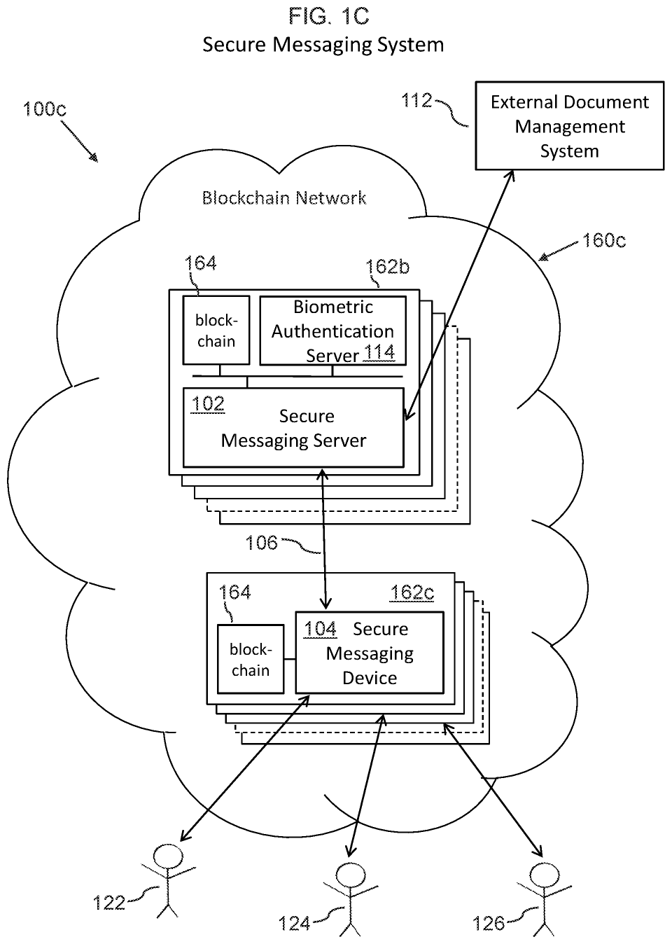

In the following, we describe the structure of an embodiment of a secure messaging system 100a with reference to FIG. 1A, in such manner that like reference numerals refer to like components throughout; a convention that we shall employ for the remainder of this specification.

In related embodiments, unlike conventional biometric access control systems, the secure messaging system 100a gives users the option to turn the biometric authentication function on/off before a file is transferred and accessed.

In further related embodiments, for example, when a user 122 sends a message object 502 (for example with attached file(s) 532) using a mobile device/PDA 104 the user has the option to turn on the biometrics function, which when turned on will enable secure sender and receiver biometric authenticated messaging. The sender also has the option to set the time the message will expire using the proprietary Expiration Clock (Automatic, 8 hours, 24 hours, 48 hours, 72 hours, etc.).

In other related embodiments, when receiving users 124 receive the file (and attachment) they must first authenticate their identity using one or more biometric sensing technologies (face recognition, touch ID, voice recognition) or other type(s) of biometric element. Once the recipient's identity is authenticated, the message object 502 and any attached file(s) 532 will automatically display.

In related embodiments, the secure messaging system 100a provides a system and method for invoking biometric sensing technologies (face recognition, touch ID, voice recognition) when transferring and accessing secured messages/files containing digital content (photos, videos, text) via a mobile application on a mobile device or personal digital assistant using a software agent.

The secure messaging system 100a can also be referred to as a Private Encrypted Content Exchange 100a, which can be abbreviated as PECX 100a. It is a biometric authentication access management system and method used to secure digital information (emails, text messages, instant messages) using biometric sensing technologies, including face, iris, voice, or fingerprint authentication. Digital content is transferred via communication or messaging protocols, i.e., SMS, XMPP, SMTP, FTTP, etc.

The secure messaging system 100a advances how end-users manage and use biometric sensing technologies (face, voice, iris or fingerprints) when transferring digital content using either a smartphone or other computing device.

In various related embodiments, the secure messaging system 100a, which can also be referred to as the PECX biometric authentication access management (BAAM) system 100a, can be controlled by the end-user and can be turned on or off whenever data is being transferred or shared using a smartphone or other computing device. This in turn forces the recipients to “authenticate” or confirm their identity to view the data using one of the biometric sensing technologies.

In a related embodiment, the secure messaging system 100a can also be used to enhance security as well as reduce the risk of hacking, data breaches, phishing, key logging, password copying, etc.

In another related embodiment, the secure messaging system 100a gives users total control of who has access to their content using the biometric authentication system, the method used to access the content (facial, voice, touch ID), and how long the content is available for viewing (Automatic, 8 hours, 24 hours, 48 hours, 72 hours, etc.).

In yet a related embodiment, the secure messaging system 100a can provide a mobile application executing on a mobile device, that provides a system and method that invokes biometric sensing technologies (face recognition, touch ID, voice) when transferring and accessing secured files containing digital content (photos, videos, text) via a mobile application on a mobile device or PDA.

In yet a related embodiment, the secure messaging system 100a can use a proprietary on-screen lock 314 to turn on biometric authentication. The secure messaging system 100a also has a proprietary Expiration Clock such that users can set the time when a message should expire.

In a related embodiment, once a message is received, the recipient is required to authenticate using one or more biometric sensing technologies (facial recognition, touch ID, voice identification, iris recognition/scanning, etc.). The systems and methods use a separate and secure network to encrypt, decrypt and store the digital content. The digital content can be stored either on the user's mobile device, PDA (personal digital assistant) or in some cloud storage, such as ICLOUD™.

In related embodiments, the type of individual or business that would use the secure messaging system 100a can be anyone concerned with privacy, controlling who and how their data is accessed, and protecting what is shared over a public or private network.

In related embodiments, the secure messaging system 100a can be used by businesses that handle very “sensitive” private data such as financial institutes, the healthcare and entertainment industry.

Thus, in various related embodiments, the secure messaging system 100a can provide privacy, security, efficiency and cost reduction. Privacy is the number one concern for consumers when it comes to digital content and sharing. Consumers are also cost conscience so having the ability to set data to automatically expire without having to manually delete the information, or pay for more storage, is huge. The secure messaging system 100 allows users to have control, and say, over who has access to their data, the method used to access the data, and controlling when and how the data is deleted. Additionally, enterprise users can reduce cost on password resets and other help desk costs incurred with help desk support.

In an embodiment, a process flow of the secure messaging system 100a can include:
a) Sign Up:
   i. Download app;
   ii. Confirm iCloud or Google Suite; and
   iii. Confirm Biometric Registration; Go to Home Page;
b) Login:
   i. Open App;
   ii. Authenticate Login, which can include performing a biometric authentication 309 of the user 122, 124, 126 who is logging in to the application; and
   iii. Go to Home Page;
c) Home Page:
   i. Provides icons to access functionality;
d) Create Message:
   i. Tap icon; Add subject; Type message; Set Expiration; Select contacts; Attach digital content; Lock message/file 502 after successful sender biometric authentication of sending user 122; If successful sender biometric authentication, then Send secure message object (i.e. with authentication flag set to true);
e) Read Message:
   i. Select message to view; perform receiver biometric authentication of receiving user 124; If receiver biometric authentication is successful then View message;
f) Reply to Message:
   i. Type message; Attach digital content; Set Expiration; perform biometric authentication of receiving user 124 (for purpose of authentication receiving user 124 as a sending user); If biometric authentication is successful then Send;
g) View Sent Messages:
   i. Tap icon; View Messages; and
h) Alerts:
   i. Tap icon; View Alerts;
   ii. Search Page.

In a related embodiment, a more detailed process flow for using the secure messaging system 100 can include:
a) First, the user downloads the application, for example from the APPLE STORE™ or GOOGLE PLAY™ ;
b) After the installation is complete, the user opens the app;
c) The “Welcome” screen appears;
d) The user taps the “Next” button;
e) The “Confirm Credentials” window appears. The user is required to confirm their credentials before proceeding, for example via:
   i. APPLE™ confirmation via iCloud; or
   ii. GOOGLE™ confirmation via GOOGLE SUITE™ ;
f) Next the Authentication window appears;
g) The User 122 authenticates their identity via biometrics, i.e., facial recognition, touch ID, voice (Note: the process of biometric authentication can be determined specifically by the type of device 104 the user is using);
h) The Home Page appears. The user 122 can take a number of actions, including:
   i. Create a Message;
   ii. Read Message;
   iii. View Sent Message;
   iv. View Alerts;
   v. Search;
i) To Create a Message, the user can tap on the icon, and:
   i. The user types a Heading in the Subject Field;
   ii. The user types a Message in the Message field;
   iii. The user sets the Expiration Clock (Automatic, 8 hours, 24 hours, 48 hours, 72 hours, etc.);
   iv. The user selects Recipients from the Contacts List;
   v. The user Attaches the digital content (photo, audio/video file document) from:
      1. Phone's 104 Gallery;
      2. An external device (for example ICLOUD™ based), external server, or external document management system 112;
      3. Record video with mobile device or PDA; and/or
      4. Take photo with the mobile device or PDA;
   vi. The user taps “Next”;
   vii. The proprietary on-screen lock displays. User can turn the biometrics feature off NOTE: the default is set to “On”. If biometrics is off, messages will be sent via conventional messaging, not requiring biometric authentication of sending users 122 and receiving users 124;
   viii. The user hits Send;
   ix. A “message sent” confirmation is shown;
   x. The app returns to the Home Page;
j) To Read Messages, user taps on icon, such that:
   i. All Unread Messages appear;
   ii. User touches the message to view;
   iii. The user authenticates access by performing a biometric authentication;
   iv. The unread message appears. The user can reply to the message by tapping the “Reply” button;
k) To Reply to a Message, user taps the Reply icon, such that:
   i. The Message field appears;
   ii. The user types the reply;
   iii. The user sets the Expiration clock (Automatic, 8 hours, 24 hrs, 48 hrs, 72 hrs, etc.);
   iv. The user Attaches the digital content (photo, video) from:
      1. Phone's 104 Gallery;
      2. An external device (for example ICLOUD™ based), external server, or external document management system 112;
      3. Record video with mobile device or PDA; and/or
      4. Take photo with the mobile device or PDA;
   v. The user taps “Next”;
   vi. The proprietary on-screen lock displays. The user 122 can turn the biometrics feature off. NOTE: the default is set to “On”.
   vii. The user hits Send; Thus, If a receiving user 124 has performed a successful biometric authentication 309 to open an initial message 502 from a sending user 122, and
      1) elects to create a reply message 502 back to the sending user 122 with the biometrics authentic flag 550 set to on/true (i.e., the receiving user 124 “locks” the reply message 502, or keeps the reply message 502 in default “locked” state, the sending user 122 will be required to perform a second biometric authentication 309 in order to access and open the reply message 502; or, alternatively
      2) elects to create a reply message 502 back to the sending user 122 with the biometrics authentic flag 550 set to off/false (i.e., if the receiving user 124 “un-locks” the reply message 502 by setting the biometrics authentic flag 550 to off/false, the sending user 122 will not be required to perform a second biometric authentication in order to access and open the reply message 502, but has then already been required to perform a first/initial biometric authentication when logging on to the secure messaging app/secure messaging device 104); and
   viii. The app returns to the Home Page;
l) To View Sent Messages, user taps the icon, such that:
   i. All Sent Messages appear;
   ii. User selects the Sent message to view; and
   iii. The Sent message appears;
m) To View Alerts, user taps the icon, such that:
   i. Alerts appear; and
   ii. Alerts are listed in chronological order from oldest to newest; and
n) To Search, user taps the icon, such that:
   i. User types in key words in the Search field; and
   ii. All content referring to the keyword(s) appear and the user can select which message to view.

Thus, in various embodiments, the secure messaging system 100a, 100b provides a number of highly useful and unique functions, including:
a) The sender has the ability to turn on or turn off the biometric access control system. In other related embodiments, the biometric systems can be controlled at the systems administrator level, which means the sender using does not control if or when a receiving user 124 is required to authenticate via biometric authentication;
b) An Expiration Clock, which lets the user determine when they want the message to expire. The clock intervals are measured in hours ranging from 24 hours through 720 hours (one month) to one year, or longer (Automatic, 8 hours, 24 hours, 48 hours, 72 hours, etc.); and
c) Alerts, which are messages that are nearing the expiration time and are listed in order from oldest to newest.

In example embodiments, secure messaging devices 104 of the secure messaging system 100a can be built on mobile platforms, such as APPLE IOS™ and ANDROID™, computers, tablets, smart TVs and other PDAs, which can be programmed using applicable/corresponding software programming languages.

Thus, in an embodiment, as shown in FIGS. 1A-1C, 2, 3, and 5, a secure messaging system 100a, 100b, 100c can include:
a) a secure messaging server 102, which can include:
   a secure message store 214, which includes a plurality of secure message objects 502; and
b) a secure messaging device 104, which can include:
   a lock dialogue 314;
wherein the secure messaging device 104 is configured to enable a sending user 122 to create a secure message object 502, wherein the secure message object 502 can include:
   message information 510;
   at least one recipient 522; and
   a biometric authentication flag 550, which can also be referred to as a biometric authentication status 550, or biometric authentication indicator 550;
wherein the lock dialogue 314 of the secure messaging device 104 is configured to enable the sending user 122 to lock the secure message object 502;
such that the secure messaging device 104 stores (and is configured to store) the secure message object 502 in the secure message store of the secure messaging server 102, if the biometric authentication flag 550 is set to true;
wherein the secure messaging device 104 is configured to enable the sending user 122 to send the secure message object 502 to the at least one receiving user 124, 126, if the biometric authentication flag 550 is set to true;
wherein optionally, when the biometric authentication flag 550 is set to false, the sending user 122 may elect to send the message object 502 as a conventional message via conventional messaging, not requiring biometric authentication.

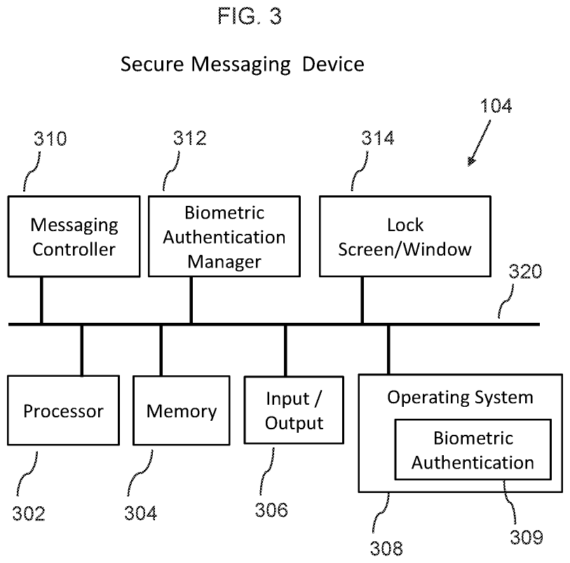

in a related embodiment, as shown in FIG. 3, the secure messaging device 104 can further include:
a) a processor 302;
b) a non-transitory memory 304;
c) an input/output component 306; and
d) a messaging controller 310, which is configured to enable a receiving user 124 to receive the secure message object 502; all connected via
e) a data bus 320;
wherein the messaging controller 310 is configured to enable a receiving user 124 to access the secure message object 502, such that the receiving user 124 opens the secure message object 502;
wherein if the biometric authentication flag 550 is set to true, the receiving user 124 is required to perform a receiver biometric authentication (i.e. a biometric authentication of the receiving user 124) prior to accessing the secure message object 502, such that if the receiver biometric authentication fails, the secure message object 502 cannot be opened.

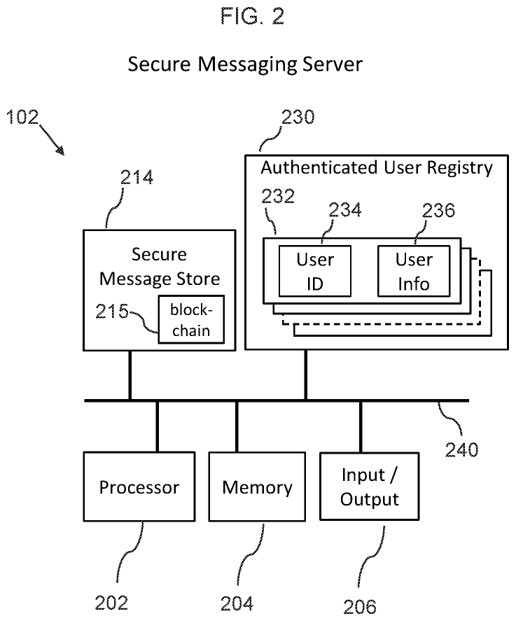

In another related embodiment, as shown in FIG. 2, the secure messaging server can further include:
a) a processor 202;
b) a non-transitory memory 204;
c) an input/output component 206; and
f) an authenticated user registry 230, which comprises at least one biometrically authenticated user record 232; all connected via
g) a data bus 240;
wherein the secure messaging device 104 is configured to enable the sending user 122 to select the at least one recipient from the authenticated user registry, in communication via the secure messaging server 102.

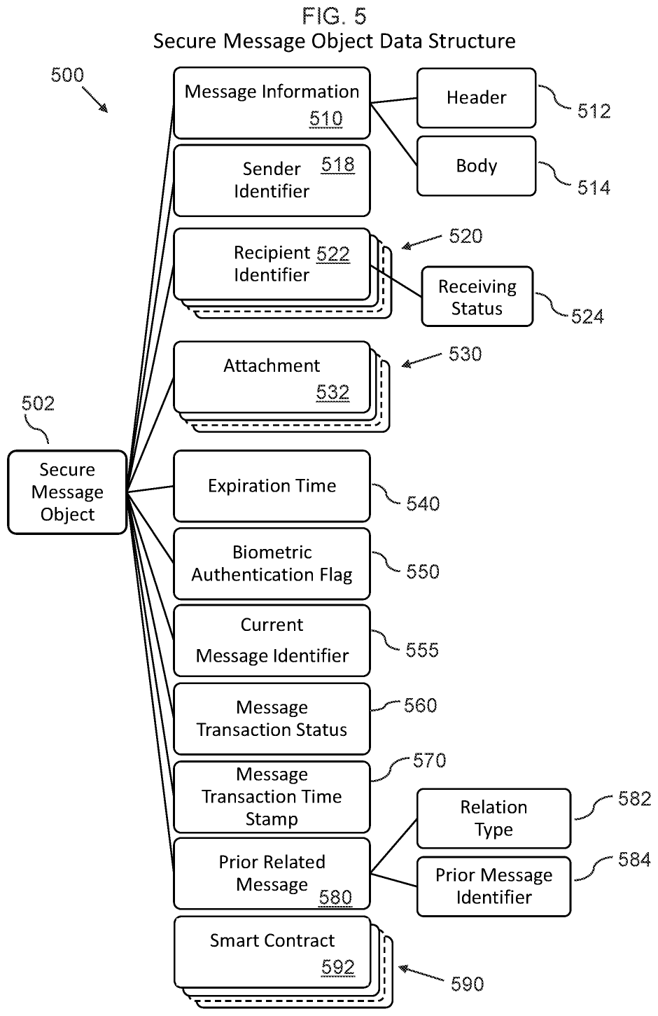

In a further related embodiment, as shown in FIG. 5, which shows a secure message object data structure 500, the secure message object 502 can further include:
at least one attachment file 530, 532.

In another further related embodiment, the secure message object 502 can further include:
an expiration time 540, which indicates when the secure message object 502 will expire.

In another further related embodiment, the secure message store 214 can be encrypted.

In related embodiments, the secure messaging device 104 can be configured to perform a biometric authentication 309 by executing an authentication function 309 supported by the operating system 308 of the secure messaging device 104. For example, on an IPHONE™, the IOS™ operating system 308, may depending on model, support a fingerprint-based biometric authentication 309, a face recognition based biometric authentication 309, an iris recognition based biometric authentication 309, a voice recognition based biometric authentication 309, or some other form of biometric authentication 309. In general, the operating system 308 can be configured to lock the device and make further user interaction impossible if a biometric authentication fails. In some alternative embodiments, wherein an operating system 308 of a secure messaging device 104 does not support biometric authentication, the secure messaging device 104 can be configured with a biometric authentication manager 312, which can be a custom developed software module that is configured/programmed to execute a biometric authentication algorithm, for example using an inbuilt camera of the secure messaging device 104.

In a related embodiment, the secure messaging device 104 can further include a lock dialogue 314 (which can also be called a lock screen 314, lock window 314, or lock module 314), which is configured to enable the sending user 122 to lock the secure message object 502, to require receiver biometric authentication. Such that if the message is not locked, the message can only be sent via conventional messaging not requiring biometric authentication.

In another related embodiment, the secure messaging system 100 can further include a biometric authentication server 114, which can be configured to perform back-end biometric authentication processing in communication with the operating system 308 of the secure messaging device 104; such that a biometric authentication 309 of the operating system 308 of the secure messaging device 104, communicates with the biometric authentication server 114 in order to process a biometric authentication of a user 122, 124. Such a biometric authentication server 114 is well-known in the art of biometric authentication, and is commonly provided as an inbuilt feature/service in mobile operating environments, such as APPLE IOS ICLOUD™, ORACLE™, etc. In some related embodiments, when biometric authentication is not provided by the underlying operating system 308, a custom developed biometric authentication manager 312 of the secure messaging device 104 and a custom developed authentication server 114 may be provided as part of the secure messaging system 100a, 100b; or instead of a custom developed authentication server 114, the associated back-end authentication processing may be provided by the secure messaging server 102.

In a related embodiment, the biometric authentication server 114 can be configured to provide biometric authentication and verification of users, and can include storage of security policies and physiological attributes such as facial image, iris, voice, and fingerprints. Additionally, the biometric authentication server 114 can provide workflow management, data management, transaction management, formatting, reporting, configuration management, fingerprint, face, voice, and iris analyzer along with other important utilities for authentication verification. As shown, the operating system 308 of the secure messaging device 104 can be configured to communicate directly with the biometric authentication server 114, but in some embodiments the secure messaging server 102 may invoke operating environment authentication functions in direct communication with the biometric authentication server 114.

In a related embodiment, the secure messaging system 100 can further include an external document management system 112 which can provide document workflow and storage, and can store secure message object 502, including attachments 530, 532, and can also store individual documents and files, to be available to attach for secure message objects 502. In some example embodiments, the secure messaging server 102 can integrate in a decoupled architecture with a financial service/bank document management system 112. In alternative embodiments, all or part of the secure messaging server 102 can integrate as embedded plug-in components, to be available as a service in a financial service/bank document management system 112. Such external document management systems 112 are well-known in the art of document management, storage, and workflow; and can include simple cloud-based storage systems 112 and document workflow management systems 112, such as bank document workflow and messaging systems 112.

Thus, in a further related embodiment, the secure messaging system 100a, 100b can further include an external document management system 112, which can be configured to provide document workflow and storage, such that the external document management system 112 can store the secure message object 502, in communication with the secure messaging server 102.

In a related embodiment, the secure messaging device 104 can be configured to enable a new user 122 to register as an authenticated user 122, such that the new user 122 is required to perform a biometric authentication 309 in order to register the new user 122, such that if (and only if) the biometric authentication succeeds, the new user 122 is added to the authenticated user registry 230 of authenticated users 122, of the secure messaging server 102.

In a related embodiment, the secure messaging device 104 can further include:
a) a biometric authentication manager 312, which is configured to execute a biometric authentication algorithm, such that the biometric authentication manager 312 processes the sender biometric authentication (typically at login only) and the receiver biometric authentication.

In another related embodiment, the secure messaging device 104 can further include:
a) an operating system 308, which is configured to provide a biometric authentication component 309, such that the biometric authentication component 309 processes the sender biometric authentication 309 (typically at login only) and the receiver biometric authentication.

In related embodiments, login biometric authentication of a user 122, 124, 126 of the secure messaging device 104 is distinct from a general login authentication provided for example by a phone with an operating system, which hosts the secure messaging device/app 104. A user 122, 124, 126 can for example be required to input a pin code to access a phone or other mobile device, but when starting/opening the secure messaging device/app 104 will be required to perform a full biometric authentication 309. Even if the phone or other mobile device is configured to require biometric authentication to access, the login biometric authentication for the secure messaging device/app 104 is a separate process that may execute a different type of biometric authentication. Login biometric authentication for the secure messaging device/app 104 can be configured to time out and require re-login to the secure messaging device/app 104, for example if a user 122, 124, 126 leaves the phone inactive for a predetermined time, and can be defined by system settings, which can be separate settings (i.e. unique to the secure messaging device/app 104) or can be derived from/shared with operating system settings of the phone or mobile device hosting the secure messaging device/app 104.

In a related embodiment, the secure messaging device 104 can be configured to enable a new user 122 to register as an authenticated user 122, such that the new user 122 is required to perform a new user biometric authentication 407 (i.e., a biometric authentication of the new user 122), such that if the new user biometric authentication 407 succeeds, a new user record 232 for the new user 122 is added to the authenticated user registry 230.

In an embodiment, as illustrated in FIG. 5, a secure message object 502 can include:
a) Message information 510, including:
   i. a message heading text 512 (i.e., for example a message subject); and
   ii. a message body text 514;
b) A sender identifier 518, which is an identification of the sending user 122;
c) at least one recipient identifier 522, or a list/plurality 520 of recipient identifiers 522, which each identify a receiving user 124, 126, wherein the recipient identifiers 522 can be selected from an authenticated user registry 230, which is stored on the secure messaging server 102; wherein each recipient identifier 522 can be associated with:
   i. a receiving status 524, which for example can be set to null, draft, sent, received, or accessed;
d) at least one attachment file 532, or a list/plurality 530 of attachment files 532, which can be selected from:
   i. a gallery/image library, which is stored on the secure messaging device 104;
   ii. An external device/storage (such as ICLOUD™ ), or external server;
   iii. a live audio/video recording taken by the secure messaging device 104;
   iv. a live photo taken by the secure messaging device 104;
e) An expiration time 540, which if filled out indicates when the message will expire (and be deleted or deactivated). The expiration time can be an absolute time stamp or a duration relative to a time of creation of the message;
f) A biometric authentication flag 550, which can be set to on or off (i.e. true/false, active/not active etc.), to indicate whether the message 502 is a secure message object 502 (i.e. with authentication flag 550 set to true), or a conventional message 502 that is not subject to biometric authentication of sending and receiving users (i.e. with authentication flag 550 set to false);
g) A current message identifier 555, which can be a generated unique identifier, such as a globally unique identifier (GUID);
h) A message status 560, which indicates a transmission status of the secure message object 502, wherein the message status 560 can be (set to) a value selected from the group including (or consisting of):
   i. draft (or new/created);
   ii. sent
      (which indicates that the message was sent by a sender 122 (identified by sender id 518), who was biometrically authenticated at login to the secure messaging device 104, which also is a login to the secure messaging system 100a, 100b, 100c);
   iii. received;
   iv. accessed
      (which indicates that the receiving user 124, 126 (identified by recipient identifier 522) was biometrically authenticated as a precondition to accessing/opening message object 502 and saving message object 502 with message status 560 accessed);
   v. expired;
   vi. deleted (for logical delete); and
   vii. etc.;
i) A message transaction time stamp 570, which can include a date and a time; and
j) A prior related message 580, which can include:
   i. a relation type 582, which can be:
      1. forward;
      2. reply; or
      3. reply-all;
   ii. a prior message identifier 584, which can be a generated unique identifier, such as a globally unique identifier (GUID);
   wherein (i.e., such that) the prior message identifier 584 identifies (i.e., links to or associates with) a prior message 502 that is sent (with relation type 582, i.e. as a forward/reply/reply-all/etc.) together with the current message object 502, such that a current message identifier 555 of the prior message object 502 is equal to (matches) the prior message identifier 584 of the current message object 502. The prior related message 580 can be null/empty if the current message object 502 is a newly created message or if any previous message/message thread has/have been deleted.

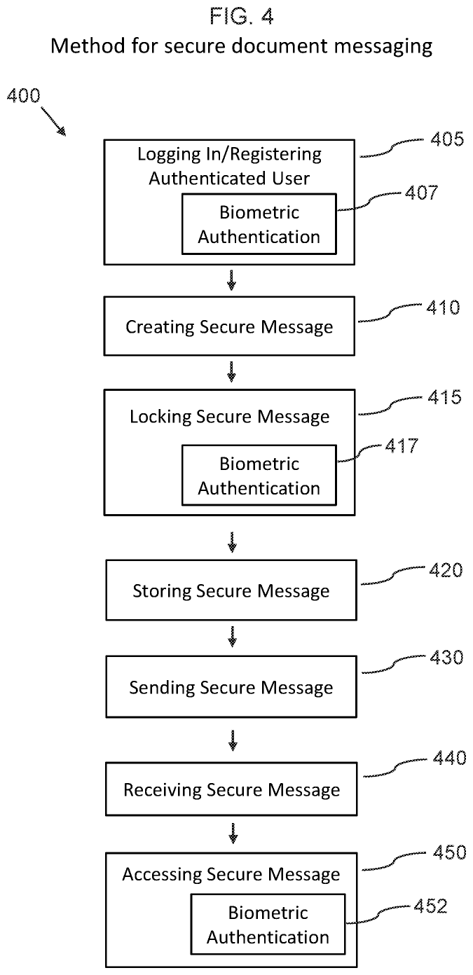

In an embodiment, as illustrated in FIG. 4, a method for secure messaging 400, can include:
a) Creating a message 410, wherein a sending user 122 creates a secure message object 502 (wherein the sending user 122 has already performed a sender biometric authentication at login);
b) Locking the message 415, wherein the biometric authentication flag 550 is set to true, such that the secure message object is locked.
   Note, that optionally the biometric authentication flag 550 can be set or defaulted to false/off (or null/inactive), such that the secure message object 502 is not locked and the messaging functionality provided by the secure messaging method 400 will for the particular message be similar to conventional messaging provided by conventional messaging systems, such as email, etc., such that no biometric authentication is required to send (typically only authenticated at login) or receive the secure message object 502. In many usage scenarios a sending user 122 may elect to only lock some secure message objects 502, for example when they contain sensitive, confidential, or privileged information;
c) Storing the message 420, wherein:
   i. the sending user 122 stores the secure message object 502 (with the authentication flag set to true) in a secure message store 214, which can be encrypted;
   Note that messages 502 with authentication flag set to off/false, can be stored locally (for example in draft status) on the secure messaging device and can be stored on external conventional messaging servers/services, such as the Apple Push Notification service™, POP3, IMAP or MS EXCHANGE™ servers, etc.;
d) Sending the message 430, the sending user 122 sends the secure message object to the recipients 520, with the biometric authentication flag 550 set to true;
e) Receiving the message 440, wherein the receiving user 124 receives the secure message object 502 to the recipients 520, for example such that the secure message object 502 becomes visible in a list of received objects in an inbox for each of the receiving users 124 in the list of recipients 520. A received locked secure message object 502 may be shown with no identifying information (such as “new locked message”), or it may additionally identify the sender 518, and in some cases optionally the message header 512; and
f) Accessing the message 450, wherein the receiving user 124 opens the secure message object 502; wherein if the biometric authentication flag 550 is set to true, the receiving user 124 is required to perform a receiver biometric authentication 452 prior to accessing the secure message object 502, such that if the receiver biometric authentication 452 fails, the secure message object 502 cannot be opened.

In a related embodiment, the method for secure messaging 400 can further include registering a new user 405, wherein a new user 122 registers as an authenticated user 122, such that the new user 122 is required to perform a new user biometric authentication 407 (i.e. a biometric authentication of the new user 122), such that if the new user biometric authentication 407 succeeds, the new user 122 is added to an authenticated user registry 230 of authenticated users 122, 124, 126. The new user registration can be done as part of a general login process step, wherein a new user 122, 124, 126 is required to perform a biometric authentication in order to register in the secure messaging system 100a, 100b, 100c. Subsequently, after initial registration, the registered user 122, 124, 126 can be required to perform a biometric authentication 309 to login to the secure messaging system 100a, 100b, 100c (via the general login process step on the secure messaging device 104).

Thus, in related embodiments, the secure messaging system 100a, 100b, 100c can be configured as secure mobile messaging system 100a, 100b, 100c for sending and received secure message, such that the secure messaging system 100a, 100b provides both network and device authentication; and user authentication of both sending users 122 and receiving users 124.

In further related embodiments, the secure messaging system 100a, 100b, 100c can be configured for instant text messaging, such that the secure message object 502 is a text message, which can for example be transmitted over a cellular phone network for example using the Short Message Service (SMS) messaging protocol, Multimedia Messaging Service (MMS), or a combination of these. Alternatively (or additionally), the text message may be sent via TCP/IP based instant messaging protocol, such as Apple Push Notification service™. APPLE™ IOS™ IMESSAGE™ is an example of a messaging system which combines use of SMS, MMS, and TCP/IP-based instant messaging.

In a related embodiment, as shown in FIGS. 1A, 1B, and 1C, the blockchain-enabled secure messaging system 100a, 100b, 100c can further include:
a) a blockchain network 160a, which can include:
   i. a plurality of computational nodes 162a, which each comprise a processor, a non-transitory memory, and an input/output component, and can execute as a physical computer device or component of a physical computer device, or can be defined in a virtual machine segment, or other physical/virtual computation environment,
      wherein each computational node 162a can include:
      1. a secure message block chain 164, which can include:
         a plurality 610 of cryptographically linked secure message blocks 612, each comprising at least one or a plurality of secure message objects 502 (i.e., each message object 502 is stored as a transaction of a block in the blockchain),
         wherein each secure message object 502 can further include:
         at least one smart contract 592 or a plurality 590 of smart contracts 592, which each include a contract program written in a scripting/programming language;
         wherein the plurality of secure message objects can be stored as a hash tree (aka Merkle tree) of cryptographically linked secure message objects 502 (i.e., blockchain transactions), or according to other well-known methods of storing transactions in a blockchain.

In various related embodiments, the blockchain network 160a can expand the blockchain using different well-known cryptographic consensus mechanisms, such as proof-of-work or proof-of stake consensus algorithms, and each blockchain block can include well-known attributes, such as a previous block hash 642, a current block hash 644 (which can be the root hash of the Merkle tree of messages/transactions), a block time stamp 646, a nonce, a blockchain network version number, etc.

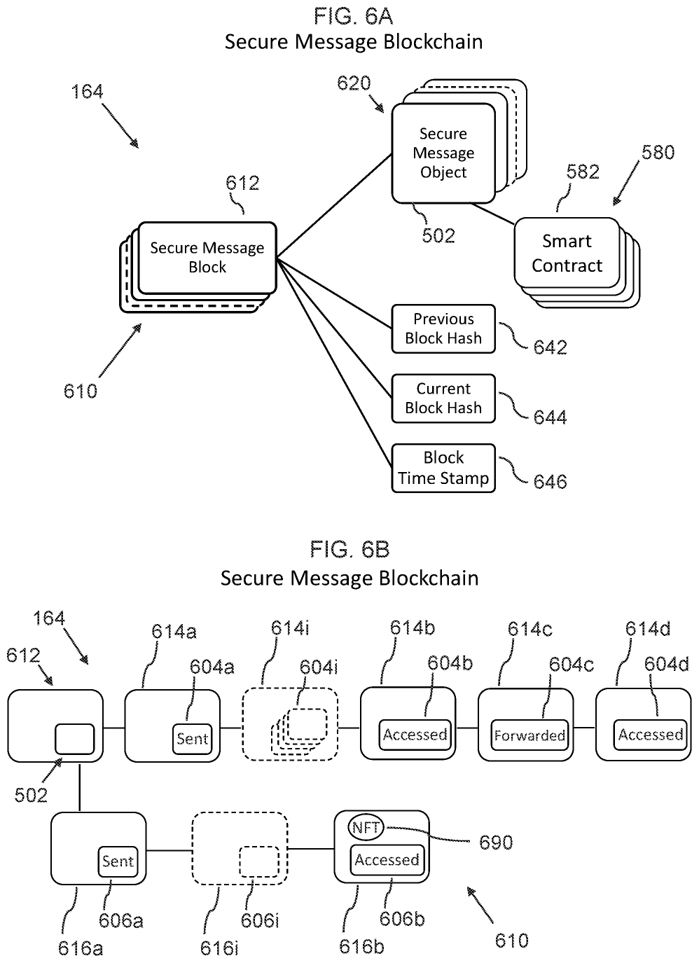

In a further related alternative embodiment, each secure message objects 502 can be associated with (i.e., linked to):
a) The at least one smart contract 592 or the plurality 590 of smart contracts 592 (instead of externally associated/linked as a part of the secure message block 612 as shown in FIG. 6A).

In a further related embodiment, the secure messaging server 102 can further include:
a) a local secure message block chain 215, which is a part of the decentralized blockchain network 160a, and is a local copy of the secure message block chain 164 of the blockchain network 160a;
wherein the local block chain 215, 164 can be stored in the secure message store 214. The secure message store 214 can comprise a first plurality of secure message objects 502 (and other messaging control variables and parameters), which define the current status of messaging and are employed to control messaging of secure message objects 502 between the secure messaging devices 104, each used by a respective user 122, 124, 126; whereas the secure message blocks 612 of the secure message block chain 164, 215 each comprise at least one secure message objects 502 or a second plurality of secure message objects 502, which record the historical status of messaging, and can be used to validate that a currently received message object 502, has a consistent history (i.e. is a true secure message that has a recorded, consensus trusted and immutable history in the block chain 164, 215, in contrast to a spoofed/injected message 502 that has no prior authentication history in the block chain 164, 215), which is termed a block chain validation of the currently received message object 502.

In a related embodiment, as shown in FIG. 1B, the blockchain network 160b can be configured such that at least one computational node 162b in the plurality of computational nodes 162a, 162b can further include:
a) the secure messaging server 102, which can for example be configured as a logical or virtual server, or a plug-in computation component that is installed/deployed on the at least one at least one computational node 162b; and
b) the biometric authentication server 114, which can for example be configured as a logical or virtual server, or a plug-in computation component that is installed/deployed on the at least one at least one computational node 162b;
wherein the blockchain network 160b is capable of hosting:
   i. decentralized applications, which can execute in a computational layer of at least one computational node 162b; and
   ii. smart contracts, which can be specified in a Turing-complete programming language, which can be interpreted or compiled.

In a further related embodiment, as shown in FIG. 1C, the blockchain network 160c can further include:
a) a second plurality of computational nodes 162c , wherein each computational node 162c can include:
   i. the secure message block chain 164, i.e., a local copy of the distributed black chains, which are subject to update by the cryptographic consensus mechanism; and
   ii. the secure messaging device 104, which can for example be configured as a logical or virtual device, or a plug-in computation component that is installed/deployed on the at least one at least one computational node 162c;
   such that a plurality of computer devices (such as mobile devices, including phones or tablets) can each host an instance of a computational node 162c in the blockchain network 160c, wherein each computational node 162c includes a local copy of the complete secure message block chain 164 and an instance of the secure messaging device 104.

In a further related example embodiment, the blockchain network 160b can be configured on the CARDANO™ public blockchain platform, such that the blockchain network 160b supports a cryptographic proof-of-stake protocol, and includes a computation layer which can support smart contracts, which can be specified in PLUTUS™, a Haskell based functional programming language; and support decentralized applications, such that the secure messaging server 102 and optionally the biometric authentication server 114 can be configured as decentralized applications on the CARDANO™ public blockchain platform.

Use of a public blockchain platform 160b, such as the CARDANO™ public blockchain platform, can ensure additional security as all users 122, 124, 126 can additionally be required to be authenticated via proprietary network authentication of the public blockchain platform 160b, and also may provide improved runtime stability with improved system availability/uptime by providing server redundancy via a large plurality of computational nodes 162b with associated computational layers; such that the secure messaging server 102 and the biometric authentication server 114 can be redeployed to a second/alternative computational node 162b, if a first/main computational node 162b crashes or is otherwise unavailable.

In a further related embodiment, as shown in FIG. 6B, when the secure messaging device 104 sends the first secure message object 502, 604a to the at least one receiving user 124, the secure messaging device 104 can be configured to save and commit the secure message object 502, 604a to a first secure message block 614a of the secure message block chain 164, wherein the message status 560 of the secure message object 502 is set to sent. A message 502 with authentication flag 550 set to false can be stored outside of the of the secure message block chain 164 and sent as a non-authenticated conventional message if the sender 122 decides to do so.

In a yet further related embodiment, when the secure messaging device 104 receives the first secure message object 502, the secure messaging device 104 can be configured to verify that the first secure message object 502 is stored in the secure message block chain 164, by searching the secure message block chain 164 for a matching secure message object 604a, with a matching message identifier 555 (i.e. wherein the current message identifier 555 of the first secure message object 502 is equal to the matching message identifier 555 of the matching secure message object 502) and with the matching message status 555 of the matching secure message object 502 set to sent, wherein (i.e, such that) the receiving secure messaging device 104 will not attempt the biometric authentication and the opening of the secure message object 502 unless the matching secure message object 502 is found in the secure message block chain 164. This blockchain validation of the secure message object 502 provides additional assurance that the secure message object 502 has not been created outside the secure messaging system 100a, 100b (i.e., spoofed) by a malicious actor, for example as part of a phishing scheme or trojan virus attack.

In related embodiments, verification of the blockchain commit of a sent message object 604a will have to wait for the containing secure message block 614a to be committed to the blockchain network 160a, 160b (when the computational nodes 162a, 162b, 162c have reached a computational consensus according to the cryptographic consensus mechanism of the blockchain network 160a, 160b, 160c). Before the commit, the search will return null/empty (indicating either that commit is still pending or possibly a forged transaction). This wait can in some blockchain network 160a, 160b take several minutes, depending on the block transaction speed of the blockchain network 160a, 160b. However, if this is a concern in some applications, the blockchain network 160a, 160b can be configured to optimize block transaction speed, for example by limiting the maximum number of message objects 502 per secure message block 612 (potentially to only 1-10 message objects 502 per secure message block 612, such that the block transaction speed can potentially be 1-100 secure message block 612 per second, thereby elimination any concerns of delayed send verification.

In a further related embodiment, when the receiver biometric authentication succeeds, the secure messaging device 104 can be configured to save and commit the secure message object 502 to a second secure message block 614b of the secure message block chain 164, wherein the receiving status 524 of the secure message object 502 is set to accessed (for the recipient identifier 522 associated with the first receiving user 124). As shown in FIG. 6B, there may be zero, one, or more intervening secure message blocks 614i, 616i (containing message object(s)/transaction(s) 604i) between blocks 614a and 614b (and also between 614b and 614c; and 614c and 614d). Note that secure message object/transactions 604a and 604b are identical with matching message ids, expect for the message status fields which are set to sent and accessed respectively. Note that FIG. 6B shows the secure message block chain 164 with a main chain and a side chain for convenience of illustration. Normally, most blocks 612 will be linked in a successively expanding main chain.

In a yet further related embodiment, the secure messaging device 104 can be configured to enable the receiving user 124 to create a second secure message object 604c, which is related to the first received secure message object 502, 604b (for example as a forward, reply, or reply-all), such that the relation type 582 is set to a sending relation and the prior message identifier is set to the message identifier of the first received secure message object 604b; wherein:
a) the secure messaging device 104 can be configured to enable the receiving user 124 (now acting as a sending/forwarding user) to send the secure message object to a second receiving user 126; and subsequently
b) the secure messaging device 104 can be configured to save and commit the second secure message object 502, 604c to a third secure message block 614c of the secure message block chain 164, wherein the message status 560 of the second secure message object 502 is set to sent (or forwarded, reply, reply-all). Note that the form of sending (new send, forward, reply, reply-all, can be determined by review of a sending relation value of the relation type 582.

Similarly, the forwarded/related message object/transaction 604c can be received, blockchain validated for presence of a message object object/transaction 604c, and a second receiving user 126 can be subject to a receiver biometric authentication of the second receiving user 126, as a precondition to accessing and opening the message object object/transaction 604c, and saving and committing to the message block 614d the message object object/transaction 604d with status set to accessed (or opened).

In a yet further related embodiment, the secure messaging device 104 can be configured to process a complete blockchain validation of a received message object 604d, which can include validating a complete chain of prior related message objects 604c, 604b, 604a, to validate (via searching of the secure message block chain 164) that each prior related message object 604c, 604b, 604a has been committed to a secure message block 614c, 614b, 614a of the secure message block chain 164; i.e. validating that each related prior message object 502, 604c, 604b, 604a has a sent and received message pair (i.e.: message object 604a+message object 604b; and message object 604c+message object 604d), for each related message in a message thread of related messages, which can be viewed as front to end validation traversal of a message thread, which starts with a most recent/last message object 604d, 604c and terminates with an oldest/first message object 604b, 604a, which has no prior related message 580.

In a related embodiment, the secure message object 502 can further include:
a) a non-fungible token smart contract 592 (or a plurality 590 of smart contracts 592); and
b) a non-fungible token source file attachment 532;
wherein the secure messaging device 104 is configured to enable the receiving user 124 to open and accept the non-fungible token smart contract 592 (after block chain validation of the sent message object 606a, successful receiver biometric authentication of the receiving user 124, and saving/opening received message object 606b);
wherein (i.e., such that) when the receiving user 124 has opened and accepted the non-fungible token smart contract 592 the secure messaging device 104 is configured to execute the non-fungible token smart contract 592, wherein the non-fungible token smart contract 592 generates a published non-fungible token 690 (i.e. “mints” a published NFT 690), which comprises the non-fungible token source file attachment 532, and wherein the secure messaging device 104 saves and commits the published non-fungible token 690 to a secure message block 616b of the secure message block chain 610.

In a further related embodiment, the secure messaging device 104 can employ a validation to ensure a published NFT 690 is only generated once from the smart contract, such as by checking that the non-fungible token smart contract 592 is not already associated with a published non-fungible token in a secure message block 616b of the secure message block chain 610, as a precondition to generating the NFT, or other well-known mechanisms to ensure unique one-time generation of a NFT 690 can be employed.

Thus, as shown in FIGS. 1A and 1B, wherein we assume all messages 502 are secure messages with authentication flag 550 set to true/on, a blockchain-enabled secure messaging system 100a, 100b can include:
a) a secure messaging server 102, which can include:
   i. a plurality of secure message objects 502; and
b) a secure messaging device 104, which can include:
   i. a processor 302;
   ii. a non-transitory memory 304; and
   iii. an input/output component 306;
wherein the secure messaging device 104 can be configured to require the sending user 122 to perform a first sender biometric authentication 309 of the sending user 122 (which can be done when logging on to the secure messaging device 104 or optionally also as secondary biometric authentication 309 immediate before getting access to creating a secure message 502);
wherein (i.e., such that):
   1) if (and only if) the first sender biometric authentication 309 succeeds, the secure messaging device 104 can be configured to enable a sending user 122 to create a first secure message object 502 and send the first secure message object 502 (with authentication flag set to true/on) to at least one receiving user 124, which includes the first receiving user 124, wherein the first secure message object 502 can includes:
      a. message information 510;
      b. a sender identifier 518, which identifies the sending user 122; and
      c. a first recipient identifier 522, which identifies the first receiving user 124; or
   2) if the first sender biometric authentication 309 fails, the secure messaging device 104 is configured to not enable the sending user 122 to send the first secure message object 502 to the at least one receiving user 124. Typically, this would mean a failure to log in to the secure messaging device 104 to access the home page of the secure messaging device 104.

In a related embodiment, the secure messaging server 102 can further include:
a) a secure message store 214, which comprises (i.e., stores) the plurality of secure message objects 502;
wherein:
   i. if the first sender biometric authentication 309 succeeds, the secure messaging device 104 is configured to store the first secure message object 502 in the secure message store 214 of the secure messaging server 102; and
   ii. if the first sender biometric authentication 309 fails, the secure messaging device 104 is configured to not allow storage of the first secure message object 502 in the secure message store 214 of the secure messaging server 102.

In another related embodiment, the secure messaging device 104 can further include:
a) a messaging controller 310, which is configured to receive the first secure message object 502 in communication with the secure message store of the secure messaging server;
wherein the messaging controller 310 is configured to require the first receiving user 124 to perform a receiver biometric authentication 309 of the first receiving user 124, wherein:
   i. if the receiver biometric authentication 309 succeeds, the messaging controller 310 is configured to enable the first receiving user 124 to access and open the first secure message object 502; and
   ii. if the receiver biometric authentication fails, the messaging controller is configured to not enable the first receiving user 124 to access the first secure message object 502, whereby the first receiving user 124 cannot open the first secure message object 502.

In a further related embodiment, the secure messaging device can further include:
a) a biometric authentication manager 312, which is configured to execute a biometric authentication algorithm, wherein the biometric authentication algorithm is configured to process the first sender biometric authentication, the first receiver biometric authentication, and the second receiver biometric authentication.

In another further related embodiment, the secure messaging device can further include:
a) an operating system 308, which comprises a biometric authentication component 309, which is configured to process the first sender biometric authentication, the first receiver biometric authentication, and the second receiver biometric authentication.

In another related embodiment, the secure messaging server 102 can further include:
a) a processor 202;
b) a non-transitory memory 204;
c) an input/output component 206; and
d) an authenticated user registry 230, which comprises at least one or a plurality of user records 232, each comprising:
   i. a user identifier 234, which identifies a user 122, 124, 126;
   ii. user information 236, which can include name, email(s), phone number(s), address, etc.; and
   iii. a private key, which is generated by the secure messaging server 102 and can be used for encryption of all information and records related to the user identifier 234 in the secure messaging system 100a, 100b, 100c;
   wherein each user record 232 can be configured as (or further include) a user smart contract in the block chain network 160a, 160b, 160c, which is defined to require authentication by the user 122, 124, 126 identified by the user identifier 234, and when the user 122, 124, 126 is authenticated, provide secure and authenticated access to data and computational components in the block chain network 160a, 160b, 160c via the private key;
wherein the secure messaging device 104 is configured to enable the sending user 122 to select the first recipient identifier 234, 522 (which identifies the first receiving user 124) from the authenticated user registry 230, in communication via the secure messaging server 102.

In a further related embodiment, the secure messaging device 104 can be configured to enable a new user 122 to register as an authenticated user 122, wherein the secure messaging device 104 is configured to require the new user 124 to perform a new user biometric authentication 309 of the new user 122, wherein:
a) if the new user biometric authentication 309 succeeds, the secure messaging device 104 is configured to add a new user record 232 representing the new user 122, 124, 126 to the authenticated user registry 230 of the secure messaging server 102;
   wherein a new user identifier 234 of the new user record 232 (and the associated new user information 236) identifies the new user 122, 124, 126; and
b) if the new user biometric authentication 309 fails, the secure messaging device 104 is configured to not enable the new user 122 to be added to the authenticated user registry 230 of the secure messaging server 102.

In another related embodiment, the secure messaging system 100a, 100b can further include:
b) a blockchain network 160a, which can include:
   ii. a plurality of computational nodes 162a, wherein each computational node 162a can include:
      1) a secure message block chain 164, which can include:
         b. a plurality 610 of cryptographically linked secure message blocks 612, each comprising at least one secure message object 502.

In a further related embodiment, the first secure message object 502 can further include:
a) a message status 560;

wherein, when the secure messaging device 104 sends the first secure message object 502, 604a to the at least one receiving user 124, 126, the secure messaging device 104 can be configured to save and commit the first secure message object 502, 604a to a first secure message block 614a of the secure message block chain 164, wherein the message status 560 of the first secure message object 502, 604a is set to sent.

In a yet further related embodiment, the first secure message object 502, 604a can further include:
a) a current message identifier 555;

wherein when the secure messaging device receives the first secure message object 502, 604a, the secure messaging device can be configured to perform a blockchain validation of the first secure message object 502, 604a with status sent, wherein the secure messaging device can be configured to verify that the first secure message object 502, 604a is stored in the secure message block chain 164 with status sent, wherein (i.e., such that) the secure messaging device is configured to search the secure message block chain for a matching secure message object 502, 604a, wherein the current message identifier 555 of the first secure message object 502 is equal to a matching message identifier 555 of the matching secure message object 604a; and wherein (i.e., such that) a matching message status of the matching secure message object 604a is set to sent;
wherein the secure messaging device 104 is configured to not attempt (i.e., not enable the user 122, 124, 126 to perform) the receiver biometric authentication and opening of the first secure message object 502, 604a unless the matching secure message object 502, 604a with status sent is (first) found in the secure message block chain, i.e. (in alternative description): wherein: if the matching secure message object is not found in the secure message block chain 164, the secure messaging device 104 is configured to not enable the first receiving user 124 to perform the receiver biometric authentication 309 and the secure messaging device 104 is configured to not enable the first receiving user 124 to access and open the first secure message object 502, 604a.

In a still further related embodiment, wherein the first secure message object 502 further comprises:
a) a receiving status 524, which is associated with the first recipient identifier 522 for the first receiving user 124;
wherein, when the receiver biometric authentication 309 succeeds:
   i. the secure messaging device 104 can be configured to save and commit the first secure message object 502, 604b to a second secure message block 614b of the secure message block chain 164, wherein the receiving status 524 associated with the first recipient identifier 522 of the first secure message object 502, 604b is set to accessed.

In another still further related embodiment, the secure messaging device 104 can be configured to enable the first receiving user 124 to create a second secure message object 502, 604c, which can further include:
a) a relation type 582, which can be forward, reply, or reply-all, etc.; and
b) a prior message identifier 584;
wherein the second secure message object 502, 604c is related to the first secure message object 502, 604b, wherein (i.e., such that) the relation type 582 is set to a sending relation (such as forward, reply, reply-all, etc.) and the prior message identifier 584 is set to the current message identifier 555 of the first secure message object 502, 604b;
wherein the secure messaging device 104 is configured to enable the first receiving user 124 to send the second secure message object 502, 604c to a second receiving user 126; and
wherein, when the secure messaging device sends the second secure message object 502, 604c to the second receiving user 126, the secure messaging device 104 is configured to save and commit the second secure message object 502, 604c to a third secure message block 614c of the secure message block chain 164, wherein the message status 560 of the second secure message object 502, 604c is set to sent, and
wherein the sender identifier 518 of the second secure message object 502, 604c identifies the first receiving user 124, and
wherein the first recipient identifier 518 of the second secure message object 502, 604c identifies the second receiving user 126.

In a yet further related embodiment, the secure messaging device 104 can be configured to process a complete blockchain validation of a newly/third received message object 604d, which can include blockchain validating the newly received message object 604d (with status sent) and blockchain validating a complete chain of prior related message objects 604c, 604b, 604a, which are related to the newly received message object 604d via the prior message identifier 584, to validate (via searching of the secure message block chain 164) that the newly received message object 604d (with status sent) and each prior related message object 604c, 604b, 604a has been committed to a corresponding block 614d, 614c, 614b, 614a of the secure message block chain 164; wherein (i.e., such that) the complete blockchain validation succeeds, if (and only if) the newly received message object 604d and all the prior related message objects 604c, 604b, 604a are found (by search) in corresponding blocks 614d, 614c, 614b, 614a of the secure message block chain 164. The prior related message objects 604c, 604b, 604a can be validated only for status accessed, only for status sent, or for a pair of status sent and status accessed.

In yet another related embodiment, the first secure message object 502 can further include:
a) a non-fungible token smart contract 592; and
b) a non-fungible token source file attachment 532;
wherein when the receiver biometric authentication 309 succeeds and the first receiving user 124 accesses and opens the first secure message object 502, 604a:
   i. the secure messaging device 104 is configured to enable the first receiving user 124 to open and accept the non-fungible token smart contract 592, wherein the secure messaging device 104 is configured to execute the non-fungible token smart contract 592, wherein the non-fungible token smart contract 592 generates a published non-fungible token 690, which comprises the non-fungible token source file attachment 532, and wherein the secure messaging device 104 saves and commits the published non-fungible token 690 to a second transaction block 616b of the secure message block chain 164.

In a further related embodiment, the first secure message object 502, 604a can further include:
a) an expiration time, which indicates when the first secure message object 502, 604a will expire and thereby indicates when the non-fungible token smart contract 592 will expire, if the non-fungible token smart contract 592 is not already accepted, wherein the secure messaging device is configured to not enable the first receiving user 124 to access and open the first secure message object 502, 604a, if the first secure message object has expired.

Thus, in an embodiment, a secure messaging system 100a, 100b, 100c can include:
a) a first secure messaging mobile device 104, which can be a smart phone (or a tablet or wearable mobile device) that can be configured to send instant text messages over cellular phone network and/or over an Internet connection ; and
b) a second secure messaging mobile device 104, which can be a smart phone (or a tablet or wearable mobile device) that can be configured to send instant text messages over cellular phone network and/or over an Internet connection;
wherein the first secure messaging mobile device 104 is configured to require the sending user 122 to perform a first sender biometric authentication 309 of the sending user 122 (typically at login to the first secure messaging mobile device 104);
wherein (i.e., such that) if the first sender biometric authentication 309 succeeds, the first secure messaging mobile device 104 is configured to enable a sending user 122 to create a first secure message object 502 and send the first secure message object 502 to the at least one receiving user 124, 126 including a first receiving user 124, wherein the first secure message object 502 comprises:
   i. message information 510, which comprises a text message 514;
   ii. a sender identifier 518, which identifies the sending user 122; and
   iii. a first recipient identifier 522, which identifies the first receiving user 124.

In a related embodiment, the second secure messaging mobile device 104 can further include:
a) a messaging controller 302, which is configured to receive the first secure message object 502;
wherein the messaging controller 302 is configured to require a first receiving user 124 to perform a receiver biometric authentication of the first receiving user 124, wherein:
   i. if the receiver biometric authentication 309 succeeds, the messaging controller 310 is configured to enable the first receiving user 124 to access and open the first secure message object 502.

Thus, in an embodiment, a method for secure messaging 400, can include:
a) performing a sender biometric authentication 407 of the sending user 122 by using a first secure messaging device 104, wherein the sender biometric authentication is processed during login to gain access to the first secure messaging device 104, wherein the first secure messaging device 104 can include:
   i. a processor 302;
   ii. a non-transitory memory 304;
   iii. an input/output component 306;
b) creating a message 410 by using the first secure messaging device 104; wherein if the sender biometric authentication 407 succeeds, a sending user 122 creates a secure message object 502, wherein the secure message object 502 can include:
   1) message information 510;
   2) a sender identifier 518, which identifies the sending user 122; and
   3) a first recipient identifier 522, which identifies a first receiving user 124; and
c) sending the message 430 by using the first secure messaging device 104, wherein if the sender biometric authentication 417 succeeds, the sending user 122 sends the secure message object 502 to the first receiving user 124 (which is identified by the first recipient identifier 522).

In a related embodiment, the method for secure messaging 400 can further include:
a) receiving the message 440 by using a second secure messaging device 104, wherein a receiving user 124 (identified by recipient identifier 522) receives the secure message object 502; and
b) accessing the message 450 by using the second secure messaging device 104, wherein the receiving user 124 performs a receiver biometric authentication 452 of the receiving user 124, wherein:
   i. if the receiver biometric authentication 452 succeeds, the receiving user 124 accesses and opens the secure message object 502; and
   ii. if the receiver biometric authentication 452 fails, the method terminates, whereby the receiving user 124 is unable to access and open the secure message object.

In related embodiments, the secure messaging device 104 can include configurations as:
a) A mobile app, executing on a mobile device, including a smartphone, such as for example an ANDROID™ phone or IPHONE™, or any wearable mobile device;
b) A tablet app, executing on a tablet device, such as for example an ANDROID™ or IOS™ tablet device;
c) A web application, executing in a web browser;
d) A desktop application, executing on a personal computer, or similar device; or
e) An embedded application, executing on a processing device, such as for example a smart TV, a game console or other system.

It shall be understood that an executing instance of an embodiment of the secure messaging system 100a, 100b, as shown in FIGS. 1A and 1B, can include a plurality of secure messaging devices 104, which are each tied to one or more users 122, 124. As shown in FIG. 1A, a sending user 122 can use a sending secure messaging device 104, to send a message 502 to a receiving user 124, who receives the message 502 on a receiving device 104. Thus, in general a user 122, 124 can act as a sending user 122, and a receiving user 124, using a secure messaging device 104, and can send and receive messages to/from a plurality of users 122, 124, which are each using a corresponding personal secure messaging device 104.

An executing instance of an embodiment of the secure messaging system 100a, 100b, as shown in FIGS. 1A and 1B, can similarly include a plurality of secure messaging servers 102.

FIGS. 1A, 1B, 2, 3, 4, 5, and 6A-6B are block diagrams and flowcharts, methods, devices, systems, apparatuses, and computer program products according to various embodiments of the present invention. It shall be understood that each block or step of the block diagram, flowchart and control flow illustrations, and combinations of blocks in the block diagram, flowchart and control flow illustrations, can be implemented by computer program instructions or other means. Although computer program instructions are discussed, an apparatus or system according to the present invention can include other means, such as hardware or some combination of hardware and software, including one or more processors or controllers, for performing the disclosed functions.

In this regard, FIGS. 1A, 1B, 2, and 3 depict the computer devices of various embodiments, each containing several of the key components of a general-purpose computer by which an embodiment of the present invention may be implemented. Those of ordinary skill in the art will appreciate that a computer can include many components. However, it is not necessary that all of these generally conventional components be shown in order to disclose an illustrative embodiment for practicing the invention. The general-purpose computer can include a processing unit and a system memory, which may include various forms of non-transitory storage media such as random access memory (RAM) and read-only memory (ROM). The computer also may include nonvolatile storage memory, such as a hard disk drive, where additional data can be stored.

FIGS. 1A and 1B show a depiction of an embodiment of the secure messaging system 100a, 100b, including the secure messaging server 102, and the secure messaging device 104. In this relation, a server shall be understood to represent a general computing capability that can be physically manifested as one, two, or a plurality of individual physical computing devices, located at one or several physical locations. A server can for example be manifested as a shared computational use of one single desktop computer, a dedicated server, a cluster of rack-mounted physical servers, a datacenter, or network of datacenters, each such datacenter containing a plurality of physical servers, or a computing cloud, such as AMAZON EC2TM or MICROSOFT AZURETM

It shall be understood that the above-mentioned components of the secure messaging server 102 and the secure messaging device 104 are to be interpreted in the most general manner.

For example, the processors 202 302 can each respectively include a single physical microprocessor or microcontroller, a cluster of processors, a datacenter or a cluster of datacenters, a computing cloud service, and the like.

In a further example, the non-transitory memory 204 and the non-transitory memory 304 can each respectively include various forms of non-transitory storage media, including random access memory and other forms of dynamic storage, and hard disks, hard disk clusters, cloud storage services, and other forms of long-term storage. Similarly, the input/output 206 and the input/output 306 can each respectively include a plurality of well-known input/output devices, such as screens, keyboards, pointing devices, motion trackers, communication ports, and so forth.

Furthermore, it shall be understood that the secure messaging server 102 and the secure messaging device 104 can each respectively include a number of other components that are well known in the art of general computer devices, and therefore shall not be further described herein. This can include system access to common functions and hardware, such as for example via operating system layers such as WINDOWS™, LINUX™, and similar operating system software, but can also include configurations wherein application services are executing directly on server hardware or via a hardware abstraction layer other than a complete operating system.

An embodiment of the present invention can also include one or more input or output components, such as a mouse, keyboard, monitor, and the like. A display can be provided for viewing text and graphical data, as well as a user interface to allow a user to request specific operations. Furthermore, an embodiment of the present invention may be connected to one or more remote computers via a network interface. The connection may be over a local area network (LAN) wide area network (WAN), and can include all of the necessary circuitry for such a connection.

In a related embodiment, the secure messaging device 104 communicates with the secure messaging server 102 over a network 106, which can include the general Internet, a Wide Area Network or a Local Area Network, or another form of communication network, transmitted on wired or wireless connections. Wireless networks can for example include Ethernet, Wi-Fi, BLUETOOTH™, ZIGBEE™, and NFC. The communication can be transferred via a secure, encrypted communication protocol.

In various related embodiment, as shown in FIGS. 1A-1C, 2, and 3, components of the secure messaging server 102 and the secure messaging device 104 can include:
a) Software modules 214, 230, 310, 312, 314, 308 which can be defined by computer program instructions for execution by a processor 202, 302. In some embodiments, parts of the software modules 214, 230, 310, 312, 314 can be compiled to hardware, such as field-programmable gate array circuits or other programmable logic hardware; and
b) Hardware components 202, 302, 204, 304, 206, 306, which can for example include a processor 202, 302, a non-transitory memory 204, 304, an input/output component 206, 306, etc.;
   wherein the Hardware components 202, 302, 204, 304, 206, 306 can be defined by circuits in silicone and/or other materials and can be mounted on a circuit board. In some embodiment, parts of the hardware components 202, 302, 204, 304, 206, 306 can be implemented as computer program instructions, including operating system code, such as BIOS code or machine code/microcode of programmable controllers.

Typically, computer program instructions may be loaded onto the computer or other general-purpose programmable machine to produce a specialized machine, such that the instructions that execute on the computer or other programmable machine create means for implementing the functions specified in the block diagrams, schematic diagrams or flowcharts. Such computer program instructions may also be stored in a computer-readable medium that when loaded into a computer or other programmable machine can direct the machine to function in a particular manner, such that the instructions stored in the computer-readable medium produce an article of manufacture including instruction means that implement the function specified in the block diagrams, schematic diagrams or flowcharts.

In addition, the computer program instructions may be loaded into a computer or other programmable machine to cause a series of operational steps to be performed by the computer or other programmable machine to produce a computer-implemented process, such that the instructions that execute on the computer or other programmable machine provide steps for implementing the functions specified in the block diagram, schematic diagram, flowchart block or step.

Accordingly, blocks or steps of the block diagram, flowchart or control flow illustrations support combinations of means for performing the specified functions, combinations of steps for performing the specified functions and program instruction means for performing the specified functions. It will also be understood that each block or step of the block diagrams, schematic diagrams or flowcharts, as well as combinations of blocks or steps, can be implemented by special purpose hardware-based computer systems, or combinations of special purpose hardware and computer instructions, that perform the specified functions or steps.

As an example, provided for purposes of illustration only, a data input software tool of a search engine application can be a representative means for receiving a query including one or more search terms. Similar software tools of applications, or implementations of embodiments of the present invention, can be means for performing the specified functions. For example, an embodiment of the present invention may include computer software for interfacing a processing element with a user-controlled input device, such as a mouse, keyboard, touch screen display, scanner, or the like. Similarly, an output of an embodiment of the present invention may include, for example, a combination of display software, video card hardware, and display hardware. A processing element may include, for example, a controller or microprocessor, such as a central processing unit (CPU), arithmetic logic unit (ALU), or control unit.

Here has thus been described a multitude of embodiments of the secure messaging system 100a, 100b, and methods related thereto, which can be employed in numerous modes of usage.

The many features and advantages of the invention are apparent from the detailed specification, and thus, it is intended by the appended claims to cover all such features and advantages of the invention, which fall within the true spirit and scope of the invention.

For example, alternative embodiments can reconfigure or combine the components of the secure messaging server 102 and the secure messaging device 104. The components of the secure messaging server 102 can be distributed over a plurality of physical, logical, or virtual servers. Parts or all of the components of the secure messaging device 104 can be configured to operate in the secure messaging server 102, whereby the secure messaging device 104 for example can function as a thin client, performing only graphical user interface presentation and input/output functions. Alternatively, parts or all of the components of the secure messaging server 102 can be configured to operate in the secure messaging device 104. Also, in other alternative embodiments, functionality of the secure messaging server 102 may be provided in the secure authentication server 114, or alternatively parts or all of functionality of the secure authentication server 114 may be provided in the secure messaging server 102.

Many such alternative configurations are readily apparent, and should be considered fully included in this specification and the claims appended hereto. Accordingly, since numerous modifications and variations will readily occur to those skilled in the art, the invention is not limited to the exact construction and operation illustrated and described, and thus, all suitable modifications and equivalents may be resorted to, falling within the scope of the invention.

What is claimed is:

1. A secure messaging system, comprising:
a) a secure messaging server, which comprises:
a plurality of secure message objects; and
b) a secure messaging device, which comprises:
a first processor;
a first non-transitory memory; and
a first input/output component;
wherein the secure messaging device is configured to require a sending user to perform a first sender biometric authentication of the sending user;
wherein if the first sender biometric authentication succeeds, the secure messaging device is configured to enable the sending user to create a first secure message object and send the first secure message object to at least one receiving user comprising a first receiving user, wherein the first secure message object comprises:
message information;
a sender identifier, which identifies the sending user; and
a first recipient identifier, which identifies the first receiving user.

2. The secure messaging system of claim 1, wherein the secure messaging server, further comprises:
a secure message store, which comprises the plurality of secure message objects;
wherein:
if the first sender biometric authentication succeeds, the secure messaging device is configured to store the first secure message object in the secure message store of the secure messaging server.

3. The secure messaging system of claim 1, wherein the secure messaging device further comprises:
a messaging controller, which is configured to receive the first secure message object;
wherein the messaging controller is configured to require the first receiving user to perform a receiver biometric authentication of the first receiving user;
wherein if the receiver biometric authentication succeeds, the messaging controller is configured to enable the first receiving user to access and open the first secure message object.

4. The secure messaging system of claim 1, wherein the secure messaging server further comprises:
a) a second processor;
b) a second non-transitory memory;
c) a second input/output component; and
d) an authenticated user registry, which comprises a plurality of user records, each comprising a user identifier and user information;
wherein the secure messaging device is configured to enable the sending user to select the first recipient identifier from the authenticated user registry, in communication via the secure messaging server.

5. The secure messaging system of claim 4, wherein the secure messaging device is configured to enable a new user to register as an authenticated user, wherein the secure messaging device is configured to require the new user to perform a new user biometric authentication of the new user, wherein:
if the new user biometric authentication succeeds, the secure messaging device is configured to add a new user record representing the new user to the authenticated user registry of the secure messaging server.

6. The secure messaging system of claim 3, further comprising:
a blockchain network, comprising:
a plurality of computational nodes, wherein each computational node comprises:
a secure message block chain, comprising:
a plurality of cryptographically linked secure message blocks, each comprising at least one secure message object.

7. The secure messaging system of claim 6, wherein the first secure message object further comprises:
a message status;
wherein when the secure messaging device sends the first secure message object to the at least one receiving user, the secure messaging device is configured to save and commit the first secure message object to a first secure message block of the secure message block chain, wherein the message status of the first secure message object is set to sent.

8. The secure messaging system of claim 7, wherein the first secure message object further comprises:
a current message identifier;
wherein when the secure messaging device receives the first secure message object, the secure messaging device is configured to verify that the first secure message object is stored in the secure message block chain with status sent, wherein the secure messaging device is configured to search the secure message block chain for a matching secure message object, wherein the current message identifier of the first secure message object is equal to a matching message identifier of the matching secure message object; and wherein a matching message status of the matching secure message object is set to sent;
wherein if the matching secure message object is not found in the secure message block chain, the secure messaging device is configured to not enable the first receiving user to perform the receiver biometric authentication and the secure messaging device is configured to not enable the first receiving user to access and open the first secure message object.

9. The secure messaging system of claim 8, wherein the first secure message object further comprises:
a receiving status, which is associated with the first recipient identifier for the first receiving user;
wherein when the receiver biometric authentication succeeds, the secure messaging device is configured to save and commit the first secure message object to a second secure message block of the secure message block chain, wherein the receiving status associated with the first recipient identifier of the first secure message object is set to accessed.

10. The secure messaging system of claim 9, wherein the secure messaging device is configured to enable the first receiving user to create a second secure message object, which further comprises:
a relation type; and
a prior message identifier;
wherein the second secure message object is related to the first secure message object, wherein the relation type is set to a sending relation and the prior message identifier is set to the current message identifier of the first secure message object;
wherein the secure messaging device is configured to enable the first receiving user to send the second secure message object to a second receiving user; and
wherein, when the secure messaging device sends the second secure message object to the second receiving user, the secure messaging device is configured to store and commit the second secure message object to a third secure message block of the secure message block chain, wherein the message status of the second secure message object is set to sent.

11. The secure messaging system of claim 10, wherein the secure messaging device is configured to process a complete blockchain validation of a newly received message object, comprising blockchain validating the newly received message object and blockchain validating a complete chain of prior related message objects, which are related to the newly received message object via the prior message identifier, to validate that the newly received message object and each prior related message object has been committed to a corresponding block of the secure message block chain, wherein the complete blockchain validation succeeds, if the newly received message object and all the prior related message objects are found in corresponding blocks of the secure message block chain.

12. The secure messaging system of claim 8, wherein the first secure message object further comprises:
a) a non-fungible token smart contract; and
b) a non-fungible token source file attachment;
wherein when the receiver biometric authentication succeeds and the first receiving user accesses and opens the first secure message object:
the secure messaging device is configured to enable the first receiving user to open and accept the non-fungible token smart contract, wherein the secure messaging device is configured to execute the non-fungible token smart contract, wherein the non-fungible token smart contract generates a published non-fungible token, which comprises the non-fungible token source file attachment; and wherein the secure messaging device saves and commits the published non-fungible token to a second secure message block of the secure message block chain.

13. The secure messaging system of claim 12, wherein the first secure message object further comprises:
an expiration time, which indicates when the first secure message object will expire and thereby indicates when the non-fungible token smart contract will expire, if the non-fungible token smart contract is not already accepted;
wherein the secure messaging device is configured to not enable the first receiving user to access and open the first secure message object, if the first secure message object has expired.

14. A secure messaging system, comprising:
a) a first secure messaging mobile device; and
b) a second secure messaging mobile device;
wherein the first secure messaging mobile device is configured to require a sending user to perform a first sender biometric authentication of the sending user;
wherein if the first sender biometric authentication succeeds, the first secure messaging mobile device is configured to enable the sending user to create a first secure message object and send the first secure message object to at least one receiving user comprising a first receiving user, wherein the first secure message object comprises:
message information, which comprises a text message;
a sender identifier, which identifies the sending user; and
a first recipient identifier, which identifies the first receiving user.

15. The secure messaging system of claim 14, wherein the second secure messaging mobile device further comprises:
a messaging controller, which is configured to receive the first secure message object;
wherein the messaging controller is configured to require the first receiving user to perform a receiver biometric authentication of the first receiving user;
wherein if the receiver biometric authentication succeeds, the messaging controller is configured to enable the first receiving user to access and open the first secure message object.

16. The secure messaging system of claim 15, further comprising:
a blockchain network, comprising:
a plurality of computational nodes, wherein each computational node comprises:
a secure message block chain, comprising:
a plurality of cryptographically linked secure message blocks, each comprising at least one secure message object.

17. The secure messaging system of claim 16, wherein the first secure message object further comprises:
a message status;
wherein when the first secure messaging mobile device sends the first secure message object to the at least one receiving user, the first secure messaging mobile device is configured to save and commit the first secure message object to a first secure message block of the secure message block chain, wherein the message status of the first secure message object is set to sent.

18. The secure messaging system of claim 17, wherein the first secure message object further comprises:
a current message identifier;
wherein when the second secure messaging mobile device receives the first secure message object, the second secure messaging mobile device is configured to verify that the first secure message object is stored in the secure message block chain with status sent, wherein the second secure messaging mobile device is configured to search the secure message block chain for a matching secure message object, wherein the current message identifier of the first secure message object is equal to a matching message identifier of the matching secure message object; and wherein a matching message status of the matching secure message object is set to sent;
wherein if the matching secure message object is not found in the secure message block chain, the second secure messaging mobile device is configured to not enable the first receiving user to perform the receiver biometric authentication and the second secure messaging mobile device is configured to not enable the first receiving user to access and open the first secure message object.

19. The secure messaging system of claim 18, wherein the first secure message object further comprises:
a receiving status, which is associated with the first recipient identifier for the first receiving user;
wherein when the receiver biometric authentication succeeds, the second secure messaging mobile device is configured to save and commit the first secure message object to a second secure message block of the secure message block chain, wherein the receiving status associated with the first recipient identifier of the first secure message object is set to accessed.

20. The secure messaging system of claim 19, wherein the second secure messaging mobile device is configured to enable the first receiving user to create a second secure message object, which further comprises:
a relation type; and
a prior message identifier;
wherein the second secure message object is related to the first secure message object, wherein the relation type is set to a sending relation and the prior message identifier is set to the current message identifier of the first secure message object;
wherein the second secure messaging mobile device is configured to enable the first receiving user to send the second secure message object to a second receiving user; and
wherein, when the second secure messaging mobile device sends the second secure message object to the second receiving user, the second secure messaging mobile device is configured to store and commit the second secure message object to a third secure message block of the secure message block chain, wherein the message status of the second secure message object is set to sent.

21. A method for secure messaging, comprising:
a) Performing a sender biometric authentication of a sending user, by using a first secure messaging device, wherein the first secure messaging device comprises:
a processor;
a non-transitory memory; and
an input/output component;
b) creating a message using the first secure messaging device;
wherein if the sender biometric authentication succeeds, the sending user creates a secure message object, wherein the secure message object comprises:
message information;
a sender identifier, which identifies the sending user; and
a first recipient identifier, which identifies a first receiving user; and
c) sending the message using the first secure messaging device, wherein if the sender biometric authentication succeeds, the sending user sends the secure message object to the at least one recipient.

22. The method for secure messaging of claim 21, further comprising:
a) receiving the message using a second secure messaging device, wherein a receiving user of the at least one recipient receives the secure message object; and
b) accessing the message using the second secure messaging device, wherein the receiving user performs a receiver biometric authentication of the receiving user, wherein:
if the receiver biometric authentication succeeds, the receiving user accesses and opens the secure message object; and
if the receiver biometric authentication fails, the method terminates, whereby the receiving user is unable to access and open the secure message object.
